(19) United States
(12) Patent Application Publication
(10) Pub. No.: US 2006/0195419 A1
(43) Pub. Date: Aug. 31, 2006

(54) Device and method for supporting material name setting, and computer product

(75) Inventors: Tsukasa Tenma, Kawasaki (JP); Tatsurou Shima, Kawasaki (JP)

Correspondence Address: STAAS & HALSEY LLP;JIM LIVINGSTON, SUITE 700, 1201 NEW YORK AVENUE, N.W., WASHINGTON, DC, 20005, US

(73) Assignee: FUJITSU LIMITED, Kawasaki (JP)

(21) Appl. No.: 11/412,949

(22) Filed: Apr. 28, 2006

Related U.S. Application Data
(63) Continuation of application No. PCT/JP04/17734, filed on Nov. 29, 2004.

(30) Foreign Application Priority Data
Nov. 28, 2003 (JP) 2003-399592

(51) Int. Cl. G06F 17/30

(52) U.S. Cl. 707/2

(57) ABSTRACT

A material name and attribute information are extracted from design data, and a reference material name corresponding to the material name is searched for from a dictionary database. When a desired search result is obtained, the search result is output. When a desired reference material name is not obtained, candidates of the reference material name having the attribute information are searched in an information database, and priorities are assigned to candidates obtained through the search, to display the candidates. A user selects a reference material name from the candidates displayed based on the priorities. The processes of selecting the material name and the reference material name selected are registered in the dictionary database and the information database.

### BACKGROUND OF THE INVENTION

1. Field of the Invention

The present invention relates to a technology for setting a material name indicated in design data or the like as a material name that can be used for analysis and calculation of environmental burdens.

2. Description of the Related Art

Names of materials are indicated in design data or the like by product names of materials or generic names of materials, but in many cases, these names cannot be used, as they are, for analysis or calculation of global environmental burdens. A designer instructs materials to be specified in manufacturing drawing as instruction to manufacture a product, but the materials can be linked to fields other than the manufacture. Because of this, names of the materials are used as attributes for analysis and calculation of the global environmental burdens.

However, the name of a material is quite often used as different names depending on fields where it is used, and hence, the name has to be used in the following manner such that a specialist finds out what it is or the name of a material is searched to find it out as a different name (material name) which is called in each field.

For example, the designer specifies a material name in manufacturing drawing to manufacture a product. The material name specified is different depending on how it is precisely specified, and the specification is provided by using a product name of the material, a generic name of the material, or “a material corresponding to so-and-so”. When a product is designed by using a three-dimensional (3D) computer aided design (CAD), a material as an attribute is set in a 3D model, but because there is limitation in characters (alphabet, kanji, katakana, half-size, and full-size, etc.) which can be used by the three-dimensional CAD, the generic name of the material is used for setting the material.

In a case of analysis which requires a physical-properties value, stress or the like is calculated based on the physical-properties value of a material to obtain the result of analysis. Materials used for analysis are made to a database (DB) of their physical-properties values using product names thereof.

When any material is to be analyzed at present and if its physical-properties value is not in the DB, it takes enormous time to acquire information for the physical-properties value, thus, the physical-properties value of a similar material is assigned to the material to analyze it.

When environmental burdens (CO₂ etc.) are to be examined based on life-cycle assessment (LCA) evaluation, unit consumption is used to calculate the environmental burdens. The unit consumption is used for materials, machining, energy, or the like, and is calculated using statistics, an inter-industry table, and so on, and hence, the unit consumptions of typical materials are made to a DB.

When the LCA evaluation is conducted at present, unit consumption of a material similar to the material is assigned from materials used for parts, and environmental burdens are calculated.

The similar problem also occurs when a chemical substance and a law on emission control for the substance are searched for. The usage of toxic substances and release thereof to environment are limited by the law. However, generic names are often used in the law, and it is thereby quite difficult to identify a particular substance. Therefore, it is not easy to search for an applied law using a name such as a trade name or a name of a product generally distributed and to learn the contents of the law.

To resolve the problems, for example, Japanese Patent Application Laid-Open No. H11-306191 discloses a search system that includes a file for managing a trade name of a product coupled to a substance name which forms the product, and a file for managing the substance name coupled to a name of a law applied thereto, and that searches for a law applied to the substance using the trade name.

Referring to chemical substances listed in a controlled substance database, for example, Japanese Patent Application Laid-Open No. 2002-83096 discloses a chemical substance control system in which a plurality of different names of a chemical substance are made to a database and it is determined whether the chemical substance used is a controlled substance.

As explained above, in the conventional technology, it is often difficult to find out a name of a material which can be used for analysis, using the name of the material specified in the design, and to acquire a physical-properties value of the material.

As material names, names as follows are used, and it is therefore difficult to search for a material name of, for example, “Pulse 1725” (product name) from the names.

Example) Materials: polycarbonate_acrylonitrile-butadiene styrene, acrylonitrile-butadiene styrene_polycarbonate, PC_ABS, ABS_PC, PC/ABS(30/70) . . . .

When a component is obtained from outside in particular, materials included in the component are not clear. Therefore, the materials are selected based on the knowledge and experience of an analyzer, which may result in poor precision of the analysis. It is also difficult for persons not related to device developers to analyze the materials without inquiry about the design.

On the other hand, when global environmental burdens are to be calculated, the similar problems also occur. As mentioned above, if environmental burdens are to be examined, the unit consumption is used to calculate environmental burdens, and unit consumptions of typical materials are made to a database.

However, it is difficult to find out a similar unit consumption from the material actually used, and hence, a value of environmental burdens varies depending on operators.

For example, when a environmental burdens calculation tool is used, an enormous number of steps are necessary to find out a material of the unit consumption.

For example, when “PC/ABS”, being a unit consumption of the material “Pulse 1725” (product name), is to be searched for, the operator has no idea about a corresponding keyword, and it is therefore difficult to search for a corresponding one from the names as follows.

Example) Materials: polycarbonate_acrylonitrile-butadiene styrene, acrylonitrile-butadiene styrene_polycarbonate, PC_ABS, ABS_PC, PC/ABS(30/70) . . . .

Moreover, there are 100 or more databases for material names, and therefore, it is quite impossible to search for a corresponding one from the list of the databases.

Furthermore, if it is a compound material, the material cannot be identified, which makes it difficult to search for a similar material, thus, leading to the poor precision of evaluation of environmental burdens. Moreover, to enhance the precision, the material needs to be divided and set, which requires an enormous number of steps.

Similarly to the above, when a component is obtained from outside, materials included in the component are not clear. Therefore, the evaluation of environmental burdens is degraded, and it is practically impossible for any person other than device developers to evaluate the environmental burdens.

### SUMMARY OF THE INVENTION

It is an object of the present invention to at least solve the problems in the conventional technology.

According to an aspect of the present invention, a material-name setting support device includes an extracting unit that extracts, from design data, a name of a notational material of a material in the design data, and attribute information including shape features of the notational material and any one of or both of physical properties and color of the notational material; a dictionary database that stores the name of the notational material coupled to a name of a reference material that becomes a preset reference; an information database that stores candidates of the name of the reference material each coupled to the attribute information; a candidate determining unit that searches for a name of a reference material corresponding to the name of the notational material extracted, from the dictionary database, outputs a search result when obtaining the search result which is desired, searches for candidates of the name of the reference material having the attribute information extracted from the design data by referring to the information database when the name of the reference material desired is not obtained, and assigns priorities to candidates obtained through the search, to output the candidates; and a candidate display unit that displays the candidates obtained, with the priorities, of the name of the reference material, and prompts a user to select a name of a reference material.

According to another aspect of the present invention, a material-name setting support device includes an extracting unit that extracts, from design data, a name of a notational material of a material in the design data, and attribute information including shape features of the notational material and any one of or both of physical properties and color of the notational material; a candidate determining unit that searches for a name of a reference material corresponding to the name of the notational material extracted, from a dictionary database which stores the name of the notational material coupled to a preset name of a reference material, outputs a search result when obtaining the search result which is desired, searches for candidates of the name of the reference material having the attribute information extracted from the design data by referring to information database which stores candidates of the name of the reference material each coupled to the attribute information, when the name of the reference material desired is not obtained, and assigns priorities to candidates obtained through the search, to output the candidates; and a candidate display unit that displays the candidates obtained, with the priorities, of the name of the reference material, and prompts a user to select a name of a reference material.

According to still another aspect of the present invention, a material-name setting support method of supporting setting of a material name and allowing a computer to execute processes, the material-name setting support method includes extracting, from design data, a name of a notational material of a material in the design data, and attribute information including shape features of the notational material and any one of or both of physical properties and color of the notational material; searching for a name of a reference material corresponding to the name of the notational material, by referring to a dictionary database that stores the name of the notational material coupled to a preset name of a reference material; outputting a search result when obtaining the search result which is desired; searching for candidates of the name of the reference material having the attribute information extracted from the design data by referring to information database that stores candidates of the name of the reference material each coupled to the attribute information when the name of the reference material desired is not obtained; and assigning priorities to candidates obtained through the search and displaying the candidates of the name of the reference material.

According to still another aspect of the present invention, a computer-readable recording medium stores therein a computer program for implementing the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of the overall configuration of a system according to one embodiment of the present invention;

FIG. 2 is a functional block diagram of a material setting device according to the embodiment;

FIG. 3A to FIG. 3D are examples of data structure of a dictionary database and an information database;

FIG. 4 is a flowchart of the process of candidate selection/decision;

FIG. 5 is a diagram of an example of attributes extracted from design model data; and

FIG. 6 is a diagram of an example of an environmental burdens database.

### DETAILED DESCRIPTION OF THE PREFERRED EMBODIMENTS

Exemplary embodiments of the present invention are explained in detail below with reference to the accompanying drawings.

A material name instructed in manufacturing drawing and a material name set in three-dimensional CAD are called “notational material name”, and a material name which becomes a preset reference is called “reference material name”.

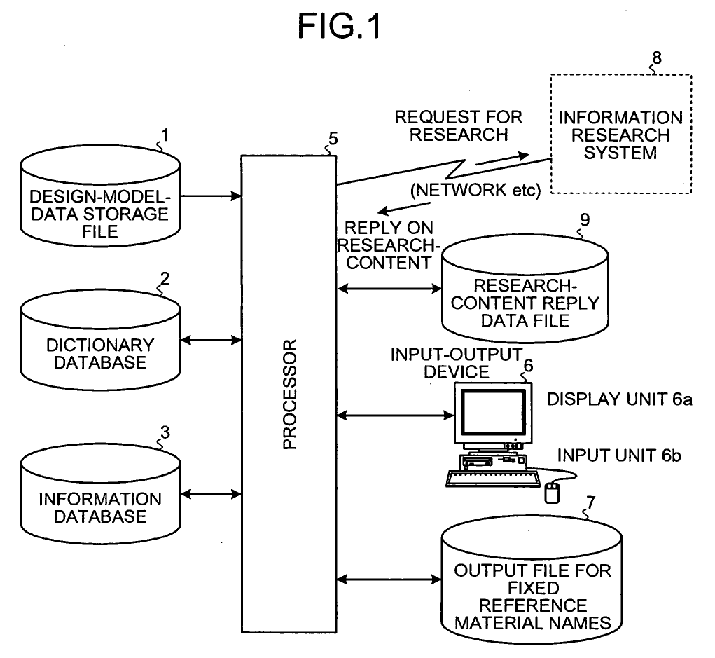

FIG. 1 is a diagram of the overall configuration of a system according to one embodiment of the present invention. The system includes a design-model-data storage file 1 that stores data for a design model such as a CAD design model, a dictionary database 2 that stores a notational material name extracted from the design model data coupled to a reference material name, and an information database 3 that stores candidates of each reference material name coupled to shape features and physical properties, respectively.

The system also includes a processor 5 and an input-output device 6 formed with a display unit 6a and an input unit 6b.

The processor 5 extracts a notational material name, shape features, and physical properties from the design model data, obtains candidates of a reference material name corresponding to the notational material name, explained later, by referring to the dictionary database 2 and the information database 3, assigns priorities to the candidates, and displays the candidates on the display unit 6a. The user selects a reference material name from the candidates displayed, based on the priorities.

The reference material name selected and the like are output to an output file 7 and also stored in the information database 3 as historical information.

The processor 5 is connected to an information research system 8 through a network or the like as necessary, sends a request to the information research system 8 to research the shape and attribute information of the material extracted from the design model data, and stores a reply to the request in a research-content reply data file 9. Then, when candidates of the reference material name are to be obtained, the attribute information stored in the research-content reply data file 9 is used.

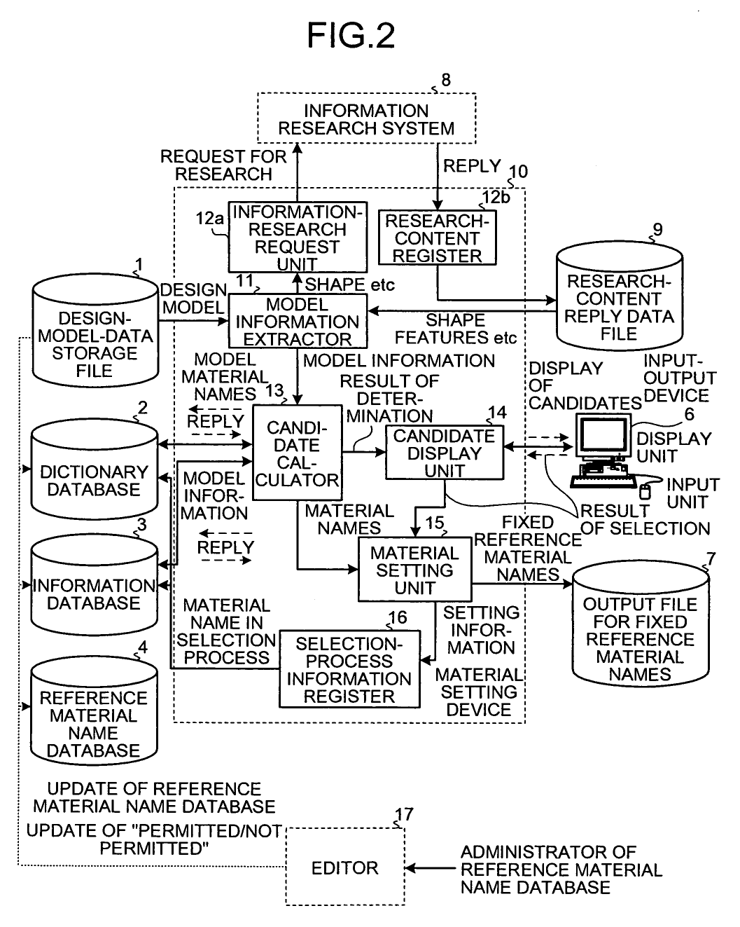

FIG. 2 is a functional block diagram of a material setting device according to the embodiment.

In FIG. 2, reference numeral 10 represents a material setting device. The material setting device 10 includes a model information extractor 11, an information-research request unit 12a, a research content register 12b, a candidate calculator 13, a candidate display unit 14, a material setting unit 15, and a selection-process information register 16. Each function of the components in the material setting device 10 can be implemented by software executed by the processor 5.

The model information extractor 11 extracts, from design model data, a notational material name (material name) of a material in the design model data and attribute information including shape features of the notational material, and physical properties and/or color of the notational material.

Furthermore, if the attribute information acquired from the design model data is insufficient, the model information extractor 11 sends a request to the information research system 8 for research, through the information-research request unit 12a, and the research content register 12b registers reply data to the request in the research-content reply data file 9.

The candidate calculator 13 decides candidates of the reference material name (or a model material name) to which priorities are assigned respectively, based on model information acquired in the model information extractor 11, by referring to the dictionary database 2 and the information database 3.

The candidate display unit 14 displays the candidates decided in the candidate calculator 13 on the display unit 6a, and the user selects a reference material name from the candidates displayed.

When the reference material name is selected from the candidates displayed, the material setting unit 15 registers the candidate selected as a fixed reference material name in the output file 7 for fixed reference material names.

The selection-process information register 16 registers selection process information, such as the number of “hits” obtained when design model data and the candidates used to select the reference material name are decided, in the dictionary database 2 and the information database 3.

In FIG. 2, reference numeral 17 represents an editor. The administrator of a reference material name database 4, which stores reference material names used for analysis and evaluation of global environmental burdens or the like, adds or changes a reference material name registered in the reference material name database 4 as needed through the editor 17. The administrator also adds a reference material name to those registered in the dictionary database 2 and the information database 3 or changes the reference material names therein, and updates a flag for “Permitted/Not permitted” (explained later) in the dictionary database 2.

Setting of a material by the material setting device 10 according to the embodiment shown in FIG. 2 is explained below.

The user enters data for a design model, which is a target to set a material name, in the material setting device 10.

The model information extractor 11 acquires, from the data for the design model, a notational material name, shape data, and attribute information for each material in the data for the design model.

The design model data holds a material name set in the three-dimensional CAD and information such as volume and surface area as attribute information, and also holds information such as an article number, a title, and a material name specified in a title block of a two-dimensional drawing.

The model information extractor 11 acquires the notational material name and the attribute information from the design model data.

The notational material name is specified in design data such as “pulse 1725” as explained above. The attribute information includes volume/shape features/weight/specific gravity/color, or the like, and specifically, “surface area: 1000 mm²”, “volume: 100 mm³” and “weight: 100 g”, etc.

Furthermore, if there is missing in the attribute information acquired from the design model data, the model information extractor 11 sends a request to the information research system 8, through the information-research request unit 12a, to research the missing attribute information.

For example, if “specific gravity” is missing in the attribute information, the model information extractor 11 transfers a notational material name such as a character string of a material on drawing (hereinafter, “material-character string on drawing”), to a specific gravity search system of the information research system 8, through the information-research request unit 12a, and receives the specific gravity.

Furthermore, the model information extractor 11 transfers CAD data to an image recognition system of the information research system 8 through the information-research request unit 12a, and acquires shape features. The shape features are information such as maximum profile/positions of projection and hole/shape outline of the projection and the hole. More specifically, the model information extractor 11 transfers CAD data such as a model image obtained from the design model data to the information research system 8, and acquires shape features such as the maximum profile and the hole position obtained from the information research system 8 (e.g., maximum profile: 100, 20, 5, and there is a large hole at the center thereof). Then, when the search is conducted from the information database 3, as explained later, the model information extractor 11 searches for a shape having features similar to the shape features.

The content obtained through the research by the information research system 8 is received by the research content register 12b, stored in the research-content reply data file 9, and is transferred to the model information extractor 11.

The candidate calculator 13 calculates candidates of a reference material name from the model information acquired by the model information extractor 11 by referring to the dictionary database 2 and the information database 3.

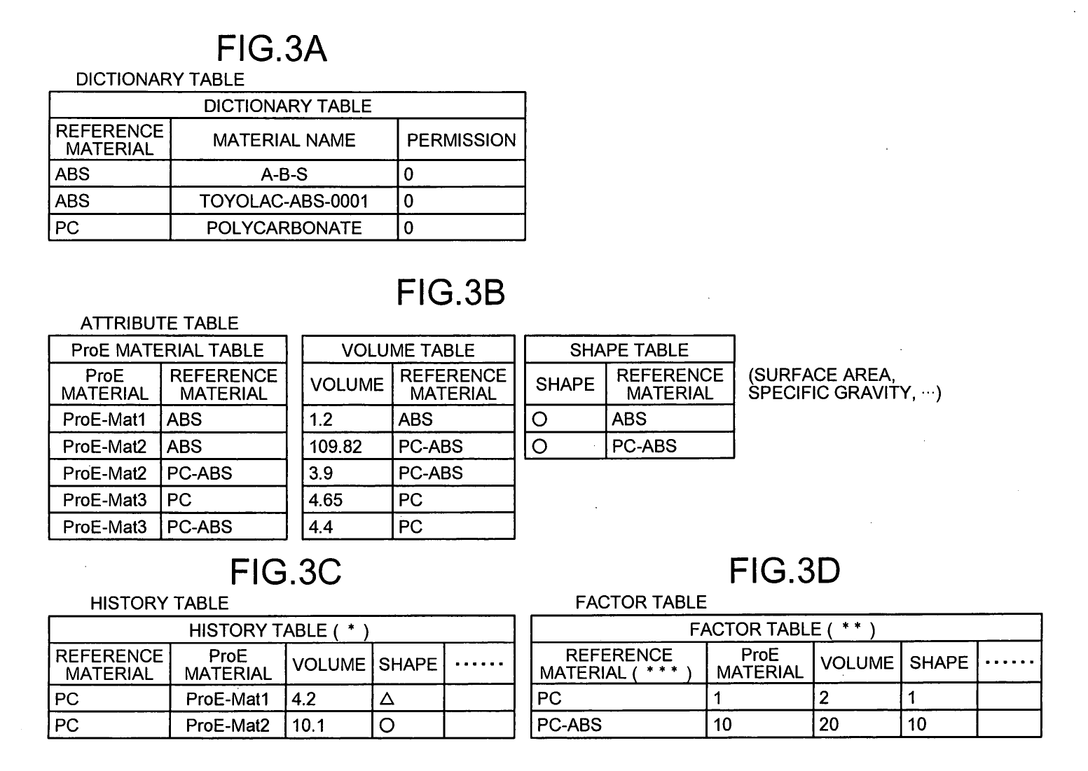

FIG. 3A to FIG. 3D are examples of data structure of the dictionary database 2 and the information database 3.

As shown in FIG. 3A, the dictionary database 2 includes a dictionary table that stores a reference material name coupled to a material name (which corresponds to the notational material name) corresponding to the reference material name. Furthermore, the dictionary table also stores a flag indicating “Permitted/Not permitted” corresponding to each reference material name. As explained above, the reference material name used for analysis and calculation of global environmental burdens or the like is added or changed as needed, and the administrator of the reference material name database 4 updates the reference material name database 4 according to the addition or the change. However, the reference material names registered in the reference material name database 4 used therefor are set to “Permitted” (flag=1) of the flag, and reference material names not registered are set to “Not permitted” (flag=0) of the flag. The default value of the flag upon automatic register is 0.

The information database 3 includes an attribute table, a history table, and a factor table as shown in FIG. 3B, FIG. 3C, and FIG. 3D, respectively.

As shown in FIG. 3B, the attribute table includes a ProE material table that stores reference material names corresponding to ProE materials respectively, a volume table that registers therein reference material names corresponding to volumes respectively, and a shape table that registers therein reference material names corresponding to shape features (the shape features are indicated here as “circle”, “triangle”, etc.). Although FIG. 3B shows only part of the attribute table, some other attribute tables are provided for surface area, a specific gravity, and the like extracted from the design model data.

As shown in FIG. 3C, the history table registers therein, without any change, each combination of attribute information in the design model data and a reference material name selected by the user, as a material selection process in the past.

As shown in FIG. 3D, the factor table registers therein the number of hits for each attribute upon searching the attribute table, each coupled to a reference material name. Each column of the reference material names in the factor table is unique, which does not allow overlapping.

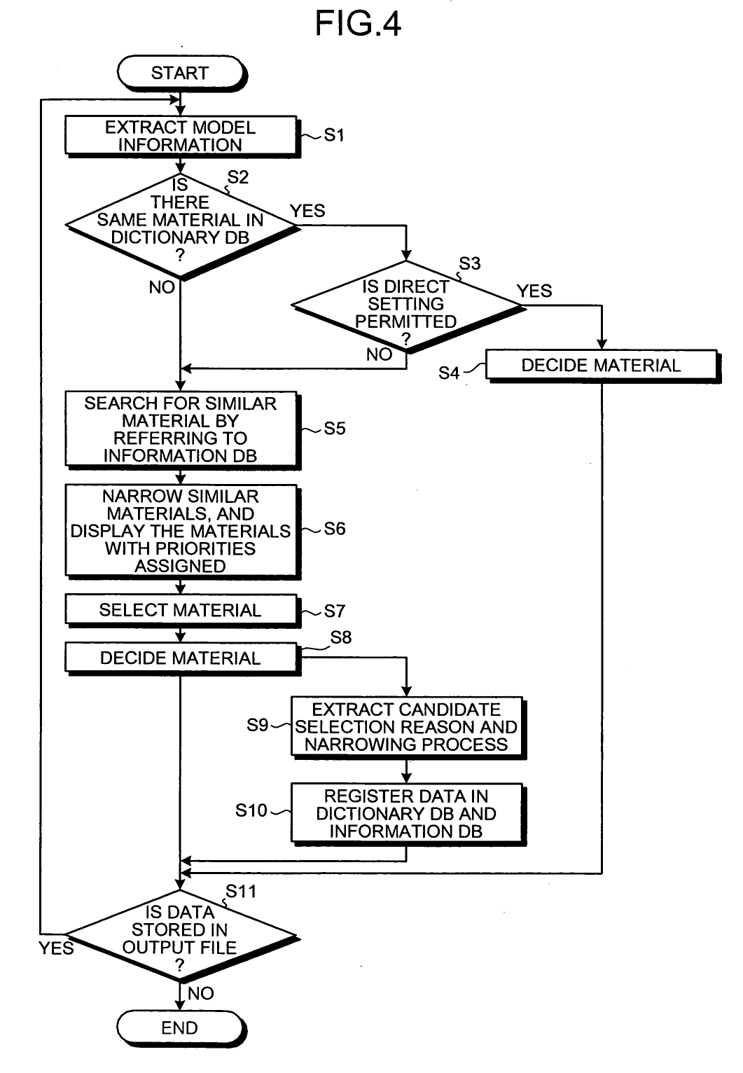

FIG. 4 is a flowchart of the process of candidate selection/decision. The outline of the candidate selection/decision process performed by the candidate calculator 13, the candidate display unit 14, and by the material setting unit 15, and the outline of the registration process in the selection-process information register 16 are explained below with reference to FIG. 4.

When the design model data is extracted, the candidate calculator 13 searches whether there is a material name the same as the notational material name described in a character string on the drawing of the design data, in the dictionary database 2 (steps S1, S2). If there is the same material name in the dictionary database 2, the candidate calculator 13 determines whether the material name is permitted or not permitted by referring to the flag for “Permitted/Not permitted” (step S3). If it is permitted, the reference material name, stored in the dictionary database 2 and corresponding to the notational material name searched for, is decided as a reference material name with first priority (step S4).

If there is the same material name in the dictionary database 2 but the flag for “Permitted/Not permitted” indicates “Not permitted”, the candidate calculator 13 searches the information database 3 for all the combinations of the attribute information extracted from the design model data, narrows similar materials as candidates, and assigns priorities to the candidates narrowed according to the number of hits (steps S5, S6).

The candidate display unit 14 displays the candidates with priorities on the display unit 6a. The user selects a reference material name as a candidate from the candidates displayed thereon, allowing for the priorities (step S7).

The material setting unit 15 outputs the reference material name with first priority and the reference material name selected to the output file 7, as fixed reference material names (steps S8, S11).

On the other hand, the selection-process information register 16 extracts a candidate narrowing process, and registers the process in the dictionary database 2 and the information database 3 (steps S9, S10).

The process of material selection/decision and the process of registering selection process information are explained using a specific example.

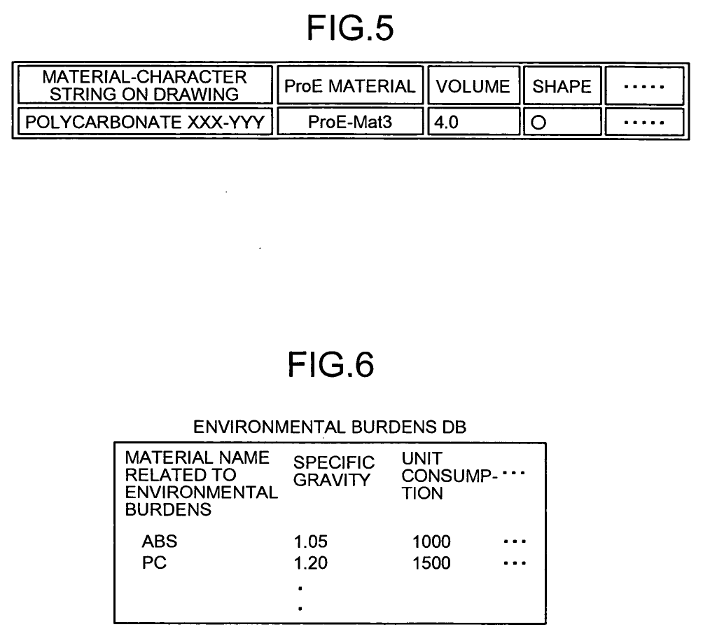

The following case is explained herein. The case is such that a character string and attribute information shown in FIG. 5 are extracted from the design model data, and that the data shown in FIG. 3 is registered in the dictionary database 2 and the information database 3.

(1) The material-character string on drawing “polycarbonate xxx-yyy” shown in FIG. 5 is used as a search key to search the dictionary database 2.

If there is any “hit”, the hit becomes a candidate as one with first priority, but there is no hit herein.

(2) The combinations of all attributes extracted from the design model data are used as search keys to search the history table in the information database 3.

If there is any hit, the hit becomes a candidate as one with second priority, but there is no hit herein.

(3) Each attribute extracted from the design model data is used as a search key to search each attribute table in the information database 3. In this case, numerical attributes such as volume and surface area are searched, allowing for a margin specified by the user. As an example here, the search is performed with a margin of 20% in upper and lower limits.

In this manner, the following candidates are searched.
A group of candidates from the ProE material table: PC, PC-ABS
A group of candidates from the volume table: PC-ABS, PC, PC
A group of candidates from the shape table: ABS, PC-ABS
   (4) The results of searches are merged to obtain the followings.
PC×3 (ProE material, volume×2)
PC-ABS×3 (ProE material, volume, shape)
ABS×1 (shape)
   (5) Because the number of hits in the attribute table of PC is the same as that of PC-ABS, priorities are decided by referring to the weight of each attribute.

The weight is determined by the number of items registered in the factor table, to obtain each reference value for evaluation. The reference value for evaluation becomes as follows, where higher priority is assigned to a material with a greater reference value for evaluation.

Referring to PC, each number of items of ProE material, volume, and shape in the factor table is 1, 2, and 1, respectively. Therefore, 1/(1+2+1) is weighted to ProE material×1 and 2/(1+2+1) is weighted to volume×2, and both of them are added, to obtain the reference value for evaluation as follows.
Reference value for evaluation (PC):
   1×1/(1+2+1)+2×2/(1+2+1)=5/4

Further, referring to PC-ABS, each number of items of ProE material, volume, and shape in the factor table is 10, 20, and 10, respectively. Therefore, 10/(10+20+10) is weighted to ProE material×1, 20/(10+20+10) is weighted to volume×1, and 10/(10+20+10) is weighted to shape×1, and all of them is added, to obtain the reference value for evaluation as follows.
Reference value for evaluation (PC-ABS):
   1×10/(10+20+10)+1×20/(10+20+10)+1×10/(10+20+10)=4/4
   (6) From these, the following results are obtained.

First priority: PC

Second priority: PC-ABS

Third priority: ABS

When the priorities are assigned in the above manner, the candidates are displayed on the display unit as explained above, to prompt the user to select any of them.

If the user selects PC which is the candidate with first priority, then the selection-process information register 16 automatically performs the following processes.

(1) A pair of the reference material name selected and the material-character string on drawing is added to the dictionary database 2.

In the above example, the pair of “PC” as the reference material name selected and “polycarbonate xxx-yyy” as the material-character string on drawing is added to the dictionary database.

(2) A pair of each attribute and the reference material is added to the attribute table in the information database 3.

Moreover, combinations of respective attributes are added to the history table, and the number of combinations is further added to the factor table.

In the above example, a combination of ProE-Mat3 and PC is added to the ProE material in the attribute table, but in this case, the combination is already in the attribute table, and so, no addition is made thereto.

A combination of volume 4.0 and PC is added to the volume table in the attribute table.

A combination of “circle” and PC is added to the shape table in the attribute table.

A combination of selected material: PC, ProE material: ProE Mat3, volume: 4.0, and shape: circle, etc. is added to the history table.

Referring to the factor table, each number of items in the “ProE material” column and “volume” column related to the record of the reference material “PC” is incremented.

The use of the material setting device according to the embodiment allows high-precision analysis and evaluation of environmental burdens without largely depending on the experience and knowledge of the user.

As explained above, the unit consumptions of typical materials used for examining environmental burdens are made to the database. An example of the environmental burdens database is shown in FIG. 6.

The environmental burdens database of FIG. 6 is used as the reference material name database 4 shown in FIG. 2 and a material name related to environmental burdens registered in the environmental burdens database is determined as the reference material name. Based on these, the material setting device according to the embodiment of the present invention decides a material name related to environmental burdens corresponding to the material name extracted from the design model data. It is thereby possible to perform high-precision evaluation on environmental burdens of designed machines and so on, without requiring a large number of steps of setting materials and also without largely depending on the knowledge and experience of an evaluator.

Likewise, in the case of analysis which requires the physical-properties value, based on a material name used for analysis which is determined as the reference material name, the material setting device according to the embodiment of the present invention decides a reference material name corresponding to the material name extracted from the design model data. It is thereby possible to perform high-precision analysis of stress calculation and so on, without requiring a large number of steps of setting materials and also without largely depending on the knowledge and experience of an evaluator.

Furthermore, the use of the material setting device according to the present invention allows search as to whether any material including controlled substances and toxic substances is used in the materials in design data or the materials forming a product.

According to the present invention, the following effects can be obtained.

(1) A name of a notational material of a material and attribute information for the notational material are extracted from data given. More specifically, the material appears in the data, and the attribute information includes shape features of the notational material and any one of or both of physical properties and color of the notational material. Then, by referring to a dictionary database, a name of a reference material corresponding to the name of the notational material extracted is searched for, from the dictionary database. When obtaining a search result which is desired, the search result is output, but when the name of the reference material desired is not obtained, candidates of the name of the reference material having the attribute information extracted from the design data are searched for by referring to information database. Then, priorities are assigned to candidates obtained through the search, and the candidates with the priorities are displayed. Thus, the number of steps of setting a material can be largely reduced.

Moreover, materials can be highly precisely set without largely depending on the experience and knowledge of the user.

(2) Results of selection by the user are accumulated as historical information in the dictionary database and the information database. It is thereby possible to set the material by referring to the results of selection in the past, which allows even a user having comparatively less experience and knowledge to set materials with high precision at any time.

(3) The present invention is linked to an external research system. When attribute information for a notational material extracted is insufficient, the research is requested to the external research system to acquire a search result. It is thereby possible to cover the material setting with required information, thus improving the precision of the material setting.

(4) By applying the present invention to analysis which requires physical-properties value and to examination of global environmental burdens, the number of steps can be reduced, and high-precision analysis and evaluation can be performed without depending on the experience and knowledge of the user.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A material-name setting support device comprising:
an extracting unit that extracts, from design data, a name of a notational material of a material in the design data, and attribute information including shape features of the notational material and any one of or both of physical properties and color of the notational material;
a dictionary database that stores the name of the notational material coupled to a name of a reference material that becomes a preset reference;
an information database that stores candidates of the name of the reference material each coupled to the attribute information;
a candidate determining unit that searches for a name of a reference material corresponding to the name of the notational material extracted, from the dictionary database, outputs a search result when obtaining the search result which is desired, searches for candidates of the name of the reference material having the attribute information extracted from the design data by referring to the information database when the name of the reference material desired is not obtained, and assigns priorities to candidates obtained through the search, to output the candidates; and
a candidate display unit that displays the candidates obtained, with the priorities, of the name of the reference material, and prompts a user to select a name of a reference material.

2. The material-name setting support device according to claim 1, further comprising:
a first register that registers, when a name of a reference material selected by the user, the name of the notational material extracted from the design data coupled to the name of the reference material selected, in the dictionary database; and
a second register that registers the name of the reference material selected and the attribute information used in the process of selecting the name of the reference material, in the information database.

3. The material-name setting support device according to claim 2, wherein the second register registers the result of selection by the user as historical information in the information database.

4. The material-name setting support device according to claim 1, further comprising:
an information-research request unit; and
a research content register, wherein
the information-research request unit sends a request to an external system for research when the attribute information for the notational material extracted by the extracting unit is insufficient, and registers the result of research as attribute information in the research content register, and
the candidate determining unit determines which candidate is appropriate for the name of the reference material, using the attribute information extracted by the extracting unit and the attribute information registered in the research content register.

5. A material-name setting support device comprising:
an extracting unit that extracts, from design data, a name of a notational material of a material in the design data, and attribute information including shape features of the notational material and any one of or both of physical properties and color of the notational material;
a candidate determining unit that searches for a name of a reference material corresponding to the name of the notational material extracted, from a dictionary database which stores the name of the notational material coupled to a preset name of a reference material, outputs a search result when obtaining the search result which is desired, searches for candidates of the name of the reference material having the attribute information extracted from the design data by referring to information database which stores candidates of the name of the reference material each coupled to the attribute information, when the name of the reference material desired is not obtained, and assigns priorities to candidates obtained through the search, to output the candidates; and
a candidate display unit that displays the candidates obtained, with the priorities, of the name of the reference material, and prompts a user to select a name of a reference material.

6. The material-name setting support device according to claim 5, further comprising:
a first register that registers, when a name of a reference material selected by the user, the name of the notational material extracted from the design data coupled to the name of the reference material selected, in the dictionary database; and
a second register that registers the name of the reference material selected and the attribute information used in the process of selecting the name of the reference material, in the information database.

7. The material-name setting support device according to claim 6, wherein the second register registers the result of selection by the user as historical information in the information database.

8. The material-name setting support device according to claim 5, further comprising:
an information-research request unit; and
a research content register, wherein
the information-research request unit sends a request to an external system for research when the attribute information for the notational material extracted by the extracting unit is insufficient, and registers the result of research as attribute information in the research content register, and
the candidate determining unit determines which candidate is appropriate for the name of the reference material, using the attribute information extracted by the extracting unit and the attribute information registered in the research content register.

9. A computer-readable recording medium that stores therein a computer program for implementing on a computer supporting setting of a material name and allowing a computer to execute processes, the computer program causing the computer to execute:
extracting, from design data, a name of a notational material of a material in the design data, and attribute information including shape features of the notational material and any one of or both of physical properties and color of the notational material;
searching for a name of a reference material corresponding to the name of the notational material, by referring to a dictionary database that stores the name of the notational material coupled to a preset name of a reference material;
outputting a search result when obtaining the search result which is desired;
searching for candidates of the name of the reference material having the attribute information extracted from the design data by referring to information database that stores candidates of the name of the reference material each coupled to the attribute information when the name of the reference material desired is not obtained; and
assigning priorities to candidates obtained through the search and displaying the candidates of the name of the reference material.

10. The computer-readable recording medium according to claim 9, further causing the computer to execute:
registering, when a name of a reference material selected by the user, the name of the notational material extracted from the design data coupled to the name of the reference material selected, in the dictionary database; and
registering the name of the reference material selected and the attribute information used in the process of selecting the name of the reference material, in the information database.

11. The computer-readable recording medium according to claim 10, wherein the registering the name of the reference material includes registering the result of selection by the user as historical information in the information database.

12. The computer-readable recording medium according to claim 9, further causing the computer to execute:
sending a request to an external system for research when the attribute information for the notational material extracted is insufficient, and registering the result of research as attribute information in a research content register; and
determining which candidate is appropriate for the name of the reference material, using the attribute information extracted in the process of extracting and the attribute information registered in the research content register.

13. A material-name setting support method of supporting setting of a material name and allowing a computer to execute processes, the material-name setting support method comprising:
extracting, from design data, a name of a notational material of a material in the design data, and attribute information including shape features of the notational material and any one of or both of physical properties and color of the notational material;
searching for a name of a reference material corresponding to the name of the notational material, by referring to a dictionary database that stores the name of the notational material coupled to a preset name of a reference material;
outputting a search result when obtaining the search result which is desired;
searching for candidates of the name of the reference material having the attribute information extracted from the design data by referring to information database that stores candidates of the name of the reference material each coupled to the attribute information when the name of the reference material desired is not obtained; and
assigning priorities to candidates obtained through the search and displaying the candidates of the name of the reference material.

14. The material-name setting support method according to claim 13, further comprising:
registering, when a name of a reference material selected by the user, the name of the notational material extracted from the design data coupled to the name of the reference material selected, in the dictionary database; and
registering the name of the reference material selected and the attribute information used in the process of selecting the name of the reference material, in the information database.

15. The material-name setting support method according to claim 14, wherein the registering the name of the reference material includes registering the result of selection by the user as historical information in the information database.

16. The material-name setting support method according to claim 13, further comprising:
sending a request to an external system for research when the attribute information for the notational material extracted is insufficient, and registering the result of research as attribute information in a research content register; and
determining which candidate is appropriate for the name of the reference material, using the attribute information extracted in the process of extracting and the attribute information registered in the research content register.
